(19) United States
(12) Patent Application Publication
(10) Pub. No.: US 2016/0207049 A1
(43) Pub. Date: Jul. 21, 2016

(54) APPARATUS AND METHOD FOR DECOMPRESSING BLOCKS OF COMPRESSED PARTICULATE MATERIAL

(71) Applicants: C. Mitchell Ellis, Semmes, AL (US); Sean Mitchell Ellis, Semmes, AL (US)

(72) Inventors: C. Mitchell Ellis, Semmes, AL (US); Sean Mitchell Ellis, Semmes, AL (US)

(73) Assignee: Mitchell Ellis Products, Inc., Semmes, AL (US)

(21) Appl. No.: 14/601,790

(22) Filed: Jan. 21, 2015

(51) Int. Cl. B02C 18/14; B02C 23/16; B02C 18/22

(52) U.S. Cl. CPC B02C 18/145; B02C 18/2216; B02C 23/16; B02C 2018/162

(57) ABSTRACT

A preferred embodiment of the invention is directed to an apparatus and method for mechanically breaking or decompressing blocks of compressed particulate material and, more specifically, to an apparatus and method for breaking apart blocks of coir, peat moss, or similar materials generally used in the horticultural industry. The apparatus can decompress particulate material in a dry state or a wet state without causing physical damage to the material. The apparatus generally comprises a breaking chamber, a rotary breaker assembly, and a screen at the bottom of the chamber through which decompressed material falls. The breaker assembly generally comprises rotary breaker bars, which decompress the particulate material as they rotate. The decompressed material then falls into a discharge chute, where it is then discharged from the apparatus for further use.

### FIELD OF THE INVENTION

The present invention refers generally to an apparatus and method for mechanically breaking or decompressing blocks of compressed particulate material.

### BACKGROUND

Coir is a natural fiber extracted from the husks of coconuts that can be used in a variety of different products. One of the primary uses for coir is as a soil additive in the horticultural industry. Coconut coir can be used as a sustainable and renewable alternative to peat moss, which takes an extremely long time to form and thus is not easily renewable. Coir provides many of the same benefits as peat moss when used as a soil additive, such as improving the structure of soil. Coir also retains moisture in soil during dry conditions and drains well during wet conditions.

Bulk coconut coir is typically supplied to the horticultural industry in the form of compressed blocks or bricks of material. Supplying compressed blocks of material is advantageous because the blocks can be shipped and handled more easily. However, the compressed blocks of coir must be broken apart, or decompressed, before the coir can be used as a soil additive. Because the blocks are highly compressed, breaking the coir apart can be difficult. Commonly, users in the horticultural industry decompress coir by soaking the blocks in water. However, the wet coir then becomes difficult to handle, particularly with respect to conventional particle handling systems used in the industry.

Thus, it is desirable to have an apparatus that can be used for decompressing coir blocks in a dry state. U.S. Pat. No. 5,839,674 to Ellis dated Nov. 24, 1998 discloses such a device. This device breaks apart dry coir blocks using a rotary breaker bar inside a breaking chamber. The breaker bar is disposed within the chamber in a spiral configuration, and as the bar rotates it causes the blocks to continually collide with each other inside the chamber. The continual collisions cause the compressed blocks to break apart. However, in recent years suppliers of coir blocks have increased the size of the blocks. The larger block size results in blocks that are more difficult to break apart using currently available technology, thereby causing the decompression process to be less efficient than desirable.

Accordingly, a need exists in the art for a device that can be used to mechanically decompress coir blocks at a greater level of efficiency than is currently achievable.

### SUMMARY

A preferred embodiment of a version of the invention is directed generally to an apparatus and method for mechanically breaking or decompressing blocks of compressed particulate material and, more specifically, to an apparatus and method for breaking apart blocks of coir, peat moss, or similar materials generally used in the horticultural industry. Furthermore, the compressed materials are decompressed into a loose mass of material without causing physical damage to the material. The decompression process is typically carried out in a dry state, though one skilled in the art would recognize that the apparatus may be operated in a wet state as well. In a dry state, the loose mass of decompressed material may be easily handled using conventional bulk handling systems.

In a preferred embodiment of the invention, compressed coir blocks are fed into a confined chamber where the blocks are broken apart into a decompressed mass of material. Inside the breaking chamber, one or more spirally-oriented breaker bars rotate around a central axle. The breaker bars are rigidly connected to the axle by support arms radially extending from the axle. As the breaker bars rotate, the blocks of compressed material are forced to collide with one another inside the breaking chamber, thereby causing the compressed blocks to break apart and form a decompressed mass of material.

To further facilitate decompression and make the process more efficient, a preferred embodiment of the invention further comprises a set of teeth connected to the breaker bars. In a preferred embodiment, the teeth point outward from the breaker bars relative to the central axle. The teeth pass in close proximity to breaking elements found along the interior of the side walls of the breaking chamber. The teeth also pass in close proximity to a screen located below the breaker bars at the bottom of the breaking chamber.

The breaking elements are attached to the side walls of the chamber and extend inward into the chamber. During normal operation, some of the compressed blocks of material (or smaller pieces of compressed material that have broken off from a block) become forced between the teeth connected to the breaker bars and the breaking elements attached to the side walls. This action causes the teeth to break apart and decompress the compressed material, thereby speeding up the process and increasing the overall efficiency of the apparatus. Furthermore, this action increases the mixing of material inside the chamber, which further reduces the original size of the compressed material inside the chamber and thereby increases the efficiency of the apparatus.

As the process continues, the compressed blocks of material turn into loose, decompressed material. This decompressed material falls to the bottom of the chamber and through the screen located below the rotary breaker bars. The material is then collected in a chute below the screen and discharged from the apparatus.

Accordingly, an object of the present invention is to provide an apparatus and method for mechanically breaking or decompressing blocks of compressed particulate material. Another object of the present invention is to provide an apparatus for decompressing blocks of compressed particulate material that operates more efficiently than other devices that are currently available.

### DESCRIPTION OF THE DRAWINGS

These and other features, aspects, and advantages of the present invention will become better understood with regard to the following description, appended claims, and accompanying drawings where:

FIG. 1 is a perspective view of an apparatus embodying features of the present invention.

FIG. 2 is a side elevational view of an apparatus embodying features of the present invention.

FIG. 3 is a top plan view of a preferred embodiment of the apparatus as depicted in FIG. 2, as taken along line 2-2 therein.

FIG. 4 is a partial view of a preferred embodiment of the breaker bar, central axle, and side wall of the apparatus depicted in FIG. 3.

FIG. 5 is a cross-sectional view of a preferred embodiment of the apparatus as depicted in FIG. 3, as taken along line 4-4 therein.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two ore more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

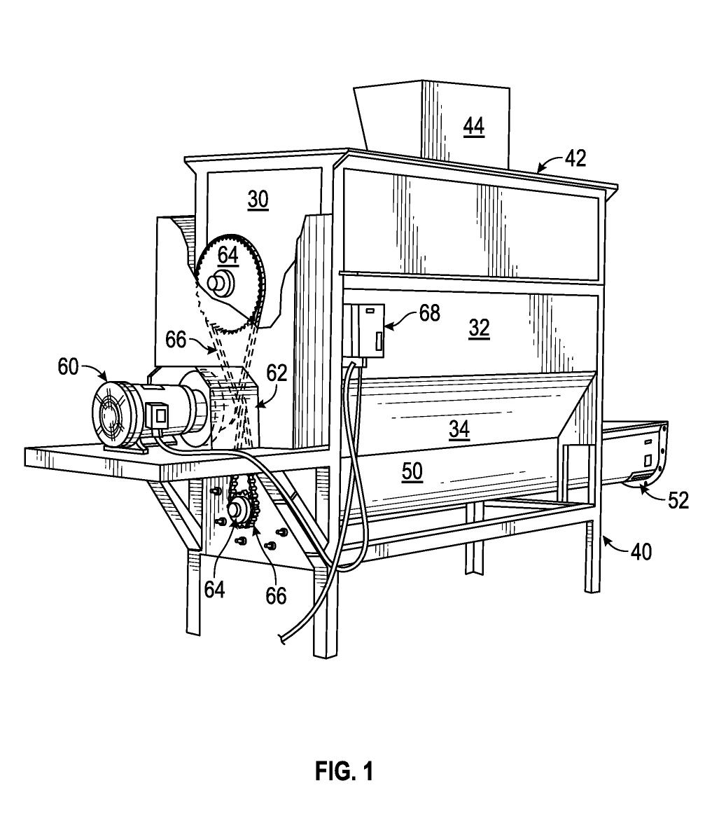

Turning now to the drawings, FIGS. 1-5 illustrate preferred embodiments of the invention. A preferred embodiment of the invention is directed generally to an apparatus and method for mechanically breaking or decompressing blocks of compressed particulate material and, more specifically, to an apparatus and method for breaking apart blocks of coir, peat moss, or similar materials generally used in the horticultural industry. The apparatus generally comprises a breaking chamber 10, a rotary breaker assembly, and a screen 18 through which decompressed material passes. The entire apparatus is supported above the ground by a frame assembly 40. These elements of the invention, as well as other features, are described in further detail below.

The breaking chamber 10 is a confined space where the compressed blocks of particulate material are broken apart into a decompressed mass of material. The breaking chamber 10 is comprised of opposed pairs of side walls 30 and end walls 32. In a preferred embodiment, the breaking chamber 10 further comprises a cover 42 over the top of the chamber 10, the cover 42 comprising a feed hopper 44 through which blocks of compressed material may be fed into the chamber 10. The breaking chamber 10 is further comprised of a pair of inwardly and downwardly inclined bottom walls 34. The bottom walls 34 are connected to a discharge chute 50, which collects decompressed material and discharges the decompressed material from the apparatus.

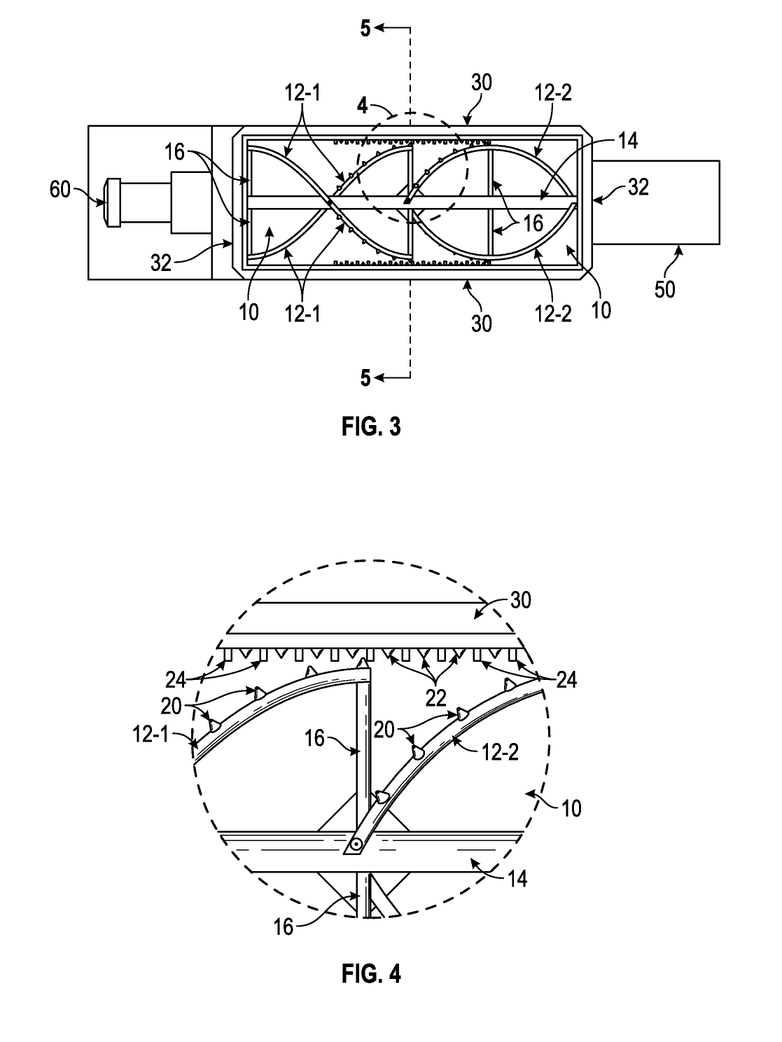

The rotary breaker assembly is housed inside the breaking chamber 10 and is comprised of a central axle 14, at least one spirally-oriented breaker bar 12-1, 12-2, and support arms 16 connecting the breaker bars 12-1, 12-2 to the central axle 14. In a preferred embodiment, as illustrated in FIG. 3, the assembly is comprised of a first pair 12-1 and a second pair 12-2 of spiral breaker bars. Each of the bars 12-1, 12-2 making up a pair are radially opposed to one another relative to the central axle 14. The spiral breaker bars 12-1, 12-2 are disposed in a concentric configuration relative to the central axle 14. The central axle 14 has two ends, each end connected to one of the end walls 32 of the breaking chamber 10. The central axle 14 is supported between the end walls 32 by suitable bearings.

In a preferred embodiment of the invention, as illustrated in FIG. 3, the first pair 12-1 of breaker bars is housed in one half of the breaking chamber 10, and the second pair 12-2 is housed in the other half of the chamber 10. As illustrated in FIGS. 3-5, the breaker bars 12-1, 12-2 are rigidly connected to the central axle 14 by a plurality of support arms 16 extending radially from the central axle 14 to the breaker bars 12-1, 12-2. The plurality of support arms 16 are connected to the central axle 14 in radially opposed pairs. The first support arm of each pair extends from the central axle 14 to one of the breaker bars 12-1, 12-2. The second support arm of the pair extends in the opposite direction from the opposite side of the central axle 14 and connects to another one of the breaker bars 12-1, 12-2, this breaker bar being radially opposed to the breaker bar connected to the first support arm.

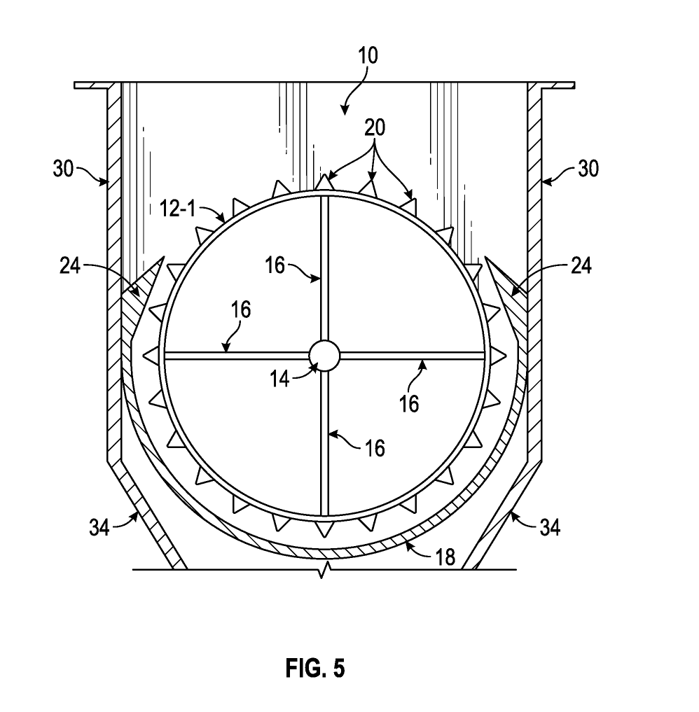

The radially opposed pairs of support arms 16 are connected to the central axle 14 at approximately equidistant intervals along the length of the axle 14. In a preferred embodiment, as illustrated in FIG. 5, each pair of support arms 16 is angularly off-set relative to an adjacent pair or pairs of support arms by approximately 90 degrees about the axis of the central axle 14. In an alternative embodiment, each pair is off-set by approximately 45 degrees. However, because the support arms 16 are connected to breaker bars 12-1, 12-2 that spiral around the central axle 14, it should be understood by one skilled in the art that the angle by which adjacent pairs of arms 16 are off-set from one another may change depending on the number of pairs of arms, and that the invention may comprise any number of support arms 16 connected to the central axle 14.

In a preferred embodiment, as illustrated in FIGS. 3-4, two pairs of support arms 16 are connected at the same point along the axis of the central axle 14 at approximately the halfway point along the axle 14. The four support arms located at this point along the axle are separated by 90 degree angles about the axis of the central axle 14. Of these two pairs of arms (each arm of one pair being radially opposed to one another), one pair of arms are each connected to the first pair 12-1 of opposed breaker bars housed in one half of the breaking chamber 10. The other pair of radially opposed support arms are each connected to the second pair 12-2 of opposed breaker bars housed in the other half of the breaking chamber 10.

In a preferred embodiment of the invention, a first plurality of teeth 20 are connected to each of the breaker bars 12-1, 12-2. In another preferred embodiment, the teeth 20 are shaped like cones and point outward relative to the central axle 14. In yet another preferred embodiment, a plurality of breaking elements 24 are attached to the interior of each of the side walls 30. The breaking elements 24 are generally vertical planar elements that are generally perpendicular to the side walls 30. In a preferred embodiment, as illustrated in FIG. 5, the breaking elements 24 are generally shaped such that each element comprises a sharp edge generally pointing upward into the breaking chamber 10. The breaking elements 24 extend into the breaking chamber 10 such that the breaker bars 12-1, 12-2 pass in close proximity to the breaking elements 24 as the breaker bars 12-1, 12-2 rotate. For instance, in a preferred embodiment, the breaker bars 12-1, 12-2 pass at a distance of less than about 1″ (one inch) from the breaking elements 24.

In addition, as illustrated in FIGS. 3-4, a preferred embodiment also comprises a second plurality of teeth 22, which are attached to the interior of each of the side walls 30. Preferably, these teeth 22 are generally positioned near the base of the breaking elements 24, with at least one tooth 22 located between each of the breaking elements 24. In a preferred embodiment, these teeth 22 are also shaped like cones and point inward into the breaking chamber 10.

Thus, a preferred embodiment of the invention is comprised of a combination of both breaking elements 24 and a plurality of teeth 22 connected to the interior of each of the side walls 30. However, an alternative embodiment may comprise only breaking elements 24 connected to the interior of each of the side walls 30. Yet another alternative embodiment may comprise only a plurality of teeth 22 connected to the interior of each of the side walls 30. In addition, another embodiment may include any number of both breaking elements 24 and teeth 22 connected to the interior of each of the side walls 30, but connected in a different configuration than the configuration illustrated in FIGS. 3-4. The numbers of breaking elements 24 and/or teeth 22 utilized in a particular embodiment will be determined based on maximizing the efficiency of the decompression process, which in turn may be determined by the properties of the particulate material being decompressed at any given time. It should be understood by one skilled in the art that particular embodiments may comprise any number of breaking elements 24 or teeth 22 connected to the interiors of the side walls 30 in any configuration and still fall within the scope of the present invention.

The relative positioning of the breaking elements 24 and both pluralities of teeth 20, 22 facilitate decompression of the blocks of compressed material and make the overall process more efficient. As the breaker bars 12-1, 12-2 rotate, the blocks of compressed material are forced to collide with one another inside the breaking chamber 10, thereby causing the compressed blocks to break apart and form a decompressed mass of material. During normal operation, some of the compressed blocks of material (or smaller pieces of compressed material that have broken off from a block) become forced between the teeth 20 connected to the breaker bars 12-1, 12-2 and the breaking elements 24 attached to the side walls 30 due to the close proximity of the breaking elements 24 to the breaker bars 12-1, 12-2 as they rotate. This action causes the teeth 20 to forcefully engage with the compressed material and break apart the material, thereby speeding up the process and increasing the overall efficiency of the apparatus.

In addition, some pieces of compressed material are forced between the breaking elements 24. These pieces are then forcefully engaged with the teeth 22 connected to the side walls 30. This action further helps in breaking apart compressed material, thereby increasing the rate of decompression and the efficiency of the apparatus. The breaking apart of compressed material by both sets of teeth 20, 22 helps to increase the mixing of material inside the breaking chamber 10. Increased mixing helps to further break apart the compressed material, which further increases the efficiency of the apparatus.

As the process continues, the compressed blocks of material turn into a loose, decompressed mass of material, which falls to the bottom of the chamber 10. The breaking chamber 10 houses a screen 18 located below the rotary breaker bars 12-1, 12-2 at the bottom of the chamber 10. The screen 18 allows decompressed particulate material to fall from the breaking chamber 10 down through the screen 18 and into the discharge chute 50. The screen 18 also supports the blocks of material inside the chamber 10 during the decompression process. In a preferred embodiment, as illustrated in FIG. 5, the screen 18 is curved such that the breaker bars 12-1, 12-2 pass in close proximity (preferably less than about 1″) to the screen 18 as the breaker bars 12-1, 12-2 rotate. The proximity of the breaker bars 12-1, 12-2 to the screen 18 prevents any pieces of compressed material from becoming trapped within the chamber 10 below the breaker bars 12-1, 12-2 where the pieces can not be easily decompressed. Thus, the proximity of the breaker bars 12-1, 12-2 to the screen 18 increases the efficiency of the apparatus.

The screen 18 is sized so as to allow decompressed particulate material to pass through the screen 18. In a preferred embodiment, the openings in the screen 18 will be larger than about 6 mm to 12 mm, which will effectively accommodate coconut coir. However, one skilled in the art would understand that the size of the openings in the screen 18 may be varied to accommodate different types of materials to be decompressed, and that different sized openings will fall with the scope of this invention.

As decompressed material falls through the screen 18, the material is collected in a chute 50 located below the screen 18, where it can then be discharged from the apparatus. The discharge chute 50 is elongated and extends outwardly from one end of the apparatus. The outwardly-extending end of the discharge chute 50 is comprised of a discharge opening 52 where decompressed material exits the apparatus. The discharge chute 50 comprises a means of conveying decompressed material toward the discharge opening 52. In preferred embodiment, the means of conveying decompressed material is a rotary auger screw 54. In an alternative embodiment, the discharge chute 50 also comprises a means of optionally spraying water onto the decompressed material as it moves through the discharge chute 50.

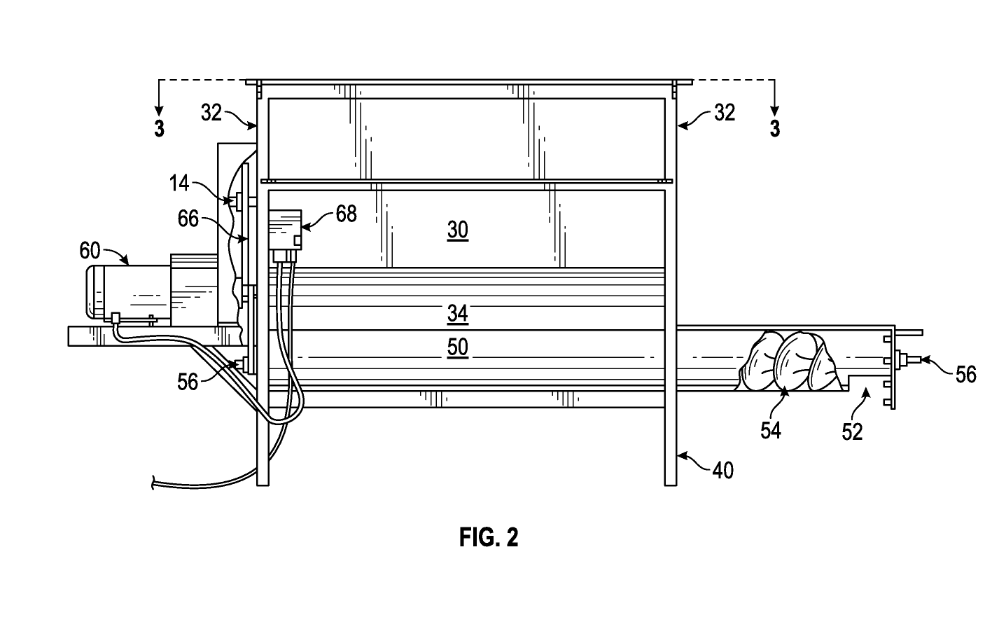

As illustrated in FIGS. 1-2, in a preferred embodiment of the invention, both the rotary auger screw 54 and the rotary breaker bars 12-1, 12-2 are operated by an electric motor 60. The electric motor 60 includes an output shaft and sprockets 62, which are coupled to a pair of drive sprockets 64 by means of drive chains 66. The pair of drive sprockets 64 are operatively connected to the central axle 14 of the rotary breaker assembly and the axle 56 of the auger screw 54, respectively. Operation of the motor 60 thereby causes the rotary breaker bars 12-1, 12-2 and the auger screw 54 to rotate concurrently with one another, but at different rotation speeds as determined by the size of the two drive sprockets 64, respectively.

When an operator is ready to begin using the apparatus, he can activate the electric motor 60 by moving a switch contained in a motor control box 68 into an “on” position. Activation of the electric motor 60 will cause the rotary breaker bars 12-1, 12-2 and the auger screw 54 to begin rotating concurrently. Blocks of compressed material may then be introduced into the breaking chamber 10 through the feed hopper 44. The rotation of the rotary breaker bars 12-1, 12-2 will then cause the compressed blocks to collide with each other in the breaking chamber 10. The collisions of the blocks will cause the blocks to break apart, thereby decompressing the material.

In a preferred embodiment, the rotary breaker bars 12-1, 12-2 will rotate in the direction that will cause the blocks of material to move to the center of the breaking chamber 10 relative to the longitudinal length of the central axle 14. As illustrated in FIGS. 3-5, the rotary breaker bars 12-1, 12-2 would rotate clockwise as observed by a viewer observing the apparatus from the discharge opening 52 at the end of the discharge chute 50. Thus, the pairs of breaker bars 12-1, 12-2 housed in opposite halves of the breaking chamber 10 will force the blocks of material to move toward the halfway point of the chamber 10. This configuration and rotation direction of the breaker bars 12-1, 12-2 will prevent blocks of compressed material from becoming lodged at either end of the chamber 10, which would result in a loss of efficiency. Additionally, forcing the blocks of material toward the center of the chamber 10 will result in more collisions as the blocks in each half of the chamber 10 are continually forced to move toward each other, thereby increasing the rate of decompression and the overall efficiency of the apparatus.

The teeth 20, 22 found on both the breaker bars 12-1, 12-2 and the side walls 30, as well as the breaking elements 24 found along the side walls 30, will forcefully engage the compressed blocks of material and thereby speed up the rate at which the blocks are broken apart. As the process of decompressing the blocks continues, decompressed material will continually fall to the bottom of the chamber 10 and through the screen 18. As it passes through the screen 18, the decompressed material will enter the discharge chute 50. As the auger screw rotates 54, this material will be conveyed to the discharge opening 52, where it will exit the apparatus. Upon exiting the apparatus, the material may be transported by any suitable means. For instance, in a dry state the decompressed material may be conveyed more conveniently by conventional particulate bulk handling systems.

In a preferred embodiment of the invention, the compressed blocks of particulate material are blocks of compressed coconut coir. However, the apparatus may be used to decompress other compressed blocks of particulate material such as peat moss blocks or any other type of horticultural or non-horticultural particulate materials.

An alternative embodiment of the invention (not shown in the drawings) also comprises a plurality of lift teeth, which are generally triangularly shaped and connected to the support arms. These lift teeth are oriented in the direction of rotation of the support arms and help to keep the compressed blocks of material moving inside the chamber. The lift teeth are an optional feature of the present invention.

It is understood that versions of the invention may come in different forms and embodiments in addition to the preferred embodiments disclosed herein. Additionally, it is understood that one of skill in the art would appreciate these various forms and embodiments as falling within the scope of the invention as disclosed herein.

What I claim as my invention is:

1. An apparatus for breaking blocks of compressed particulate material, comprising:
a. a breaking chamber in which blocks of compressed particulate material are broken to form a decompressed mass of the particulate material, the breaking chamber comprised of opposed pairs of side walls and end walls;
b. a rotary breaker assembly disposed within the breaking chamber, the rotary breaker assembly further comprising:
i. a central axle having two ends, each end connected to one of the end walls of the breaking chamber,
ii. at least one spirally-oriented breaker bar concentrically disposed relative to said central axle,
iii. a plurality of teeth connected to said spirally-oriented breaker bar, and
iv. support arms radially extending from said central axle and rigidly interconnecting said central axle and said spirally-oriented breaker bar; and,
c. a screen disposed within the breaking chamber below said rotary breaker assembly to allow the decompressed particulate material to pass through said screen.

2. The apparatus of claim 1, further comprising a plurality of breaking elements disposed along the interior of each of the side walls of the breaking chamber, each breaking element positioned such that the breaker bar passes in close proximity to said breaking elements as the breaker bar rotates, thereby facilitating the breaking of compressed particulate material.

3. The apparatus of claim 2, wherein each breaking element comprises a generally vertical planar element connected to a side wall and extending into the breaking chamber in a direction generally perpendicular to the side wall.

4. The apparatus of claim 1, said teeth having a generally conical shape.

5. The apparatus of claim 1, said teeth oriented such that the teeth are generally pointing outward relative to the central axle.

6. The apparatus of claim 1, further comprising a second plurality of teeth connected to the interior of each of the side walls of the breaking chamber.

7. The apparatus of claim 6, the second plurality of teeth disposed such that at least one tooth is positioned between each of the breaking elements.

8. The apparatus of claim 1, wherein said screen is curved such that the breaker bar passes in close proximity to the screen as the breaker bar rotates.

9. The apparatus of claim 1, further comprising a discharge chute disposed below said breaking chamber for receiving said decompressed particulate material which passes through said screen.

10. The apparatus of claim 9, wherein said discharge chute further comprises a discharge opening and a conveyor for moving said decompressed particulate material in said discharge chute toward said discharge opening.

11. The apparatus of claim 10, wherein said conveyor is a rotary auger screw.

12. The apparatus of claim 11, further comprising a motor drive assembly comprising an electric motor and a drive shaft, said drive shaft being operatively connected to both said central axle of said rotary breaker and said auger screw, whereby said rotary breaker and said auger screw are simultaneously rotated in response to operation of said electric motor.

13. An apparatus for breaking blocks of compressed particulate material, comprising:
a. a breaking chamber in which blocks of compressed particulate material are broken to form a decompressed mass of the particulate material, the breaking chamber comprised of opposed pairs of side walls and end walls;
b. a rotary breaker assembly disposed within the breaking chamber, the rotary breaker assembly further comprising:
i. a central axle having two ends, each end connected to one of the end walls of the breaking chamber,
ii. two opposed pairs of spirally-oriented breaker bars, each bar concentrically disposed relative to said central axle,
iii. a plurality of generally conically shaped teeth connected to each of the spirally-oriented breaker bars, said teeth oriented such that the teeth are generally pointing outward relative to the central axle, and
iv. support arms radially extending from said central axle and rigidly interconnecting said central axle and said spirally-oriented breaker bars;
c. a screen disposed within the breaking chamber below said rotary breaker assembly to allow the decompressed particulate material to pass through said screen, said screen being curved such that the breaker bars pass in close proximity to the screen as the breaker bars rotate; and,
d. a plurality of breaking elements disposed along each of the side walls of the breaking chamber, each breaking element comprising a generally vertical planar element connected to a side wall and extending into the breaking chamber in a direction generally perpendicular to the side wall, each breaking element positioned such that the breaker bars pass in close proximity to said breaking elements as the breaker bars rotate, thereby facilitating the breaking of compressed particulate material.

14. The apparatus of claim 13, further comprising a second plurality of teeth connected to the interior of each of the side walls of the breaking chamber.

15. The apparatus of claim 14, the second plurality of teeth disposed such that at least one tooth is positioned between each of the breaking elements.

16. The apparatus of claim 13, further comprising a discharge chute disposed below said breaking chamber for receiving said decompressed particulate material which passes through said screen.

17. The apparatus of claim 16, wherein said discharge chute further comprises a discharge opening and a conveyor for moving said decompressed particulate material in said discharge chute toward said discharge opening.

18. The apparatus of claim 17, wherein said conveyor is a rotary auger screw.

19. The apparatus of claim 18, further comprising a motor drive assembly comprising an electric motor and a drive shaft, said drive shaft being operatively connected to both said central axle of said rotary breaker and said auger screw, whereby said rotary breaker and said auger screw are simultaneously rotated in response to operation of said electric motor.

20. A method for decompressing blocks of compressed particulate material comprising the steps of:
a. providing an apparatus for breaking blocks of compressed particulate material, the apparatus comprising:
i. a breaking chamber in which blocks of compressed particulate material are broken to form a decompressed mass of the particulate material, the breaking chamber comprised of opposed pairs of side walls and end walls;
ii. a rotary breaker assembly disposed within the breaking chamber, the rotary breaker further comprising:
1. a central axle having two ends, each end connected to one of the end walls of the breaking chamber,
2. at least one spirally-oriented breaker bar concentrically disposed relative to said central axle,
3. a plurality of teeth connected to said spirally-oriented breaker bar, and
4. support arms radially extending from said central axle and rigidly interconnecting said central axle and said spirally-oriented breaker bar; and,
iii. a screen disposed within the breaking chamber below said rotary breaker assembly to allow the decompressed particulate material to pass through said screen;
b. causing the breaker bar to rotate by activating a motor having a drive shaft, said drive shaft being operatively connected to said central axle, said central axle being rigidly interconnected to said breaker bar;
c. introducing blocks of compressed particulate material into the breaking chamber such that the blocks of compressed particulate material are physically contacted with the rotating breaker bar, thereby causing the blocks of compressed material to become a decompressed mass of material; and,
d. collecting the decompressed mass of material as the decompressed mass of material falls through a screen located below the breaker bar.
